(19) United States
(12) Patent Application Publication
(10) Pub. No.: US 2010/0201460 A1
(43) Pub. Date: Aug. 12, 2010

(54) RESONATOR AND FILTER USING THE SAME

(75) Inventors: Masaya Tamura, Osaka (JP); Toshio Ishizaki, Hyogo (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/674,078

(22) PCT Filed: Aug. 20, 2008
(86) PCT No.: PCT/JP2008/002247

§ 371 Date: Feb. 18, 2010

(30) Foreign Application Priority Data
Aug. 24, 2007 (JP) 2007-217941

(51) Int. Cl. H01P 1/203; H01P 7/00

(52) U.S. Cl. 333/204; 333/219

(57) ABSTRACT

The resonator includes first high-impedance wiring plate-like, arranged parallel to top-surface ground electrode; second high-impedance wiring plate-like, arranged so as to face first high-impedance wiring; first columnar conductor electrically connecting first high-impedance wiring to second high-impedance wiring; first low-impedance wiring arranged between first high-impedance wiring and second high-impedance wiring; second columnar conductor electrically connecting first high-impedance wiring to first low-impedance wiring; second low-impedance wiring arranged between first low-impedance wiring and second high-impedance wiring; and third columnar conductor electrically connecting second high-impedance wiring to second low-impedance wiring, to reduce the area size the resonator.

### TECHNICAL FIELD

The present invention relates to a resonator used for various types of electronic appliances such as a mobile phone and to a filter and an electronic device including the resonator.

### BACKGROUND ART

FIG. 12 is a top view of a conventional resonator. In FIG. 12, there are plate-like low-impedance wiring 1a, 1b and plate-like high-impedance wiring 2a, 2b arranged on the same plane. Then, one end of low-impedance wiring 1a is electrically connected to one end of high-impedance wiring 2a. Similarly, one end of low-impedance wiring 1b is electrically connected to one end of high-impedance wiring 2b. Further, the other end of high-impedance wiring 2a is electrically connected to the other end of high-impedance wiring 2b. Prior art documents on this patent application include patent literature 1, for instance.

In the configuration of the above-described conventional resonator, however, with plate-like low-impedance wiring 1a, 1b and plate-like high-impedance wiring 2a, 2b arranged on the same plane, the area size of the resonator is given by summing the area sizes of four wiring 1a, 1b, 2a, 2b. Accordingly, reducing the area size of a resonator is difficult.
[Patent literature 1] Japanese Patent Unexamined Publication No. 1102-249303

### SUMMARY OF THE INVENTION

The present invention helps reduce the area size of a resonator.

A resonator of the present invention includes a top-surface ground electrode; a plate-like first high-impedance wiring arranged parallel to the top-surface ground electrode; a plate-like second high-impedance wiring arranged so as to face the first high-impedance wiring; a first columnar conductor electrically connecting the first high-impedance wiring to the second high; a first low-impedance wiring arranged between the first and second high-impedance wiring; a second columnar conductor electrically connecting the first high-impedance wiring to the first low; and a third columnar conductor electrically connecting the second high-impedance wiring to the second low. Such a configuration allows the resonator to be structured three-dimensionally. The area size of a resonator is reduced by making the size smaller than the sum of the area sizes of the first and second high-impedance wiring, and the first and second low-impedance wiring.

### BRIEF DESCRIPTION OF DRAWINGS

FIG. 1 is a perspective view of a resonator according to the first exemplary embodiment of the present invention.

FIG. 2A is a sectional view of the resonator according to the first embodiment of the present invention.

FIG. 2B is an enlarged figure of one half side of the sectional view of the resonator according to the first embodiment of the present invention.

FIG. 2C is a sectional view of FIG. 2B viewed from the top surface.

FIG. 3 is a perspective view showing an example configuration for characterizing the resonator according to the first embodiment of the present invention.

FIG. 4 is a characteristic diagram of the resonator according to the first embodiment of the present invention.

FIG. 5 is another characteristic diagram of the resonator according to the first embodiment of the present invention.

FIG. 6 is a perspective view of another resonator according to the first embodiment of the present invention.

FIG. 7 is a perspective view showing another embodiment of the resonator according to the first embodiment of the present invention.

FIG. 8 is a perspective view showing a filter including the resonator according to the first embodiment of the present invention.

FIG. 9 is a perspective view of a resonator according to the second exemplary embodiment of the present invention.

FIG. 10 is a perspective view of another resonator according to the second embodiment of the present invention.

FIG. 11 is a perspective view showing another resonator according to the second embodiment of the present invention.

FIG. 12 is a top view of a conventional resonator.

### REFERENCE MARKS IN THE DRAWINGS

3, 13 Dielectric laminated substrate

4, 14 Top-surface ground electrode

5, 15 Bottom-surface ground electrode

6a, 6b, 16a, 16b Side-surface ground electrode

7a, 17a First high-impedance wiring

7b, 17b Second high-impedance wiring

8a, 18a First low-impedance wiring

8b, 18b Second low-impedance wiring

9a, 19a First columnar conductor

9b, 19b Second columnar conductor

9c, 19c Third columnar conductor

10a, 10b I/O terminal

11a, 11b Columnar conductor

12a, 12b I/O wiring

20a, 20b, 21a, 21b Loading capacitance

22 Virtual ground surface

23 Interstage coupling device

24a, 24b Input coupling device

25a, 25b Output coupling device

### DETAILED DESCRIPTION OF PREFERRED EMBODIMENTS

### First Exemplary Embodiment

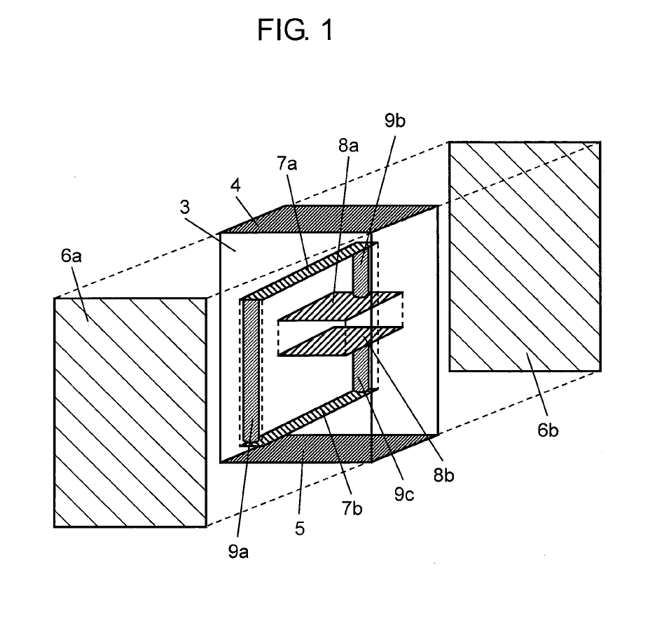

FIG. 1 is a perspective view of a resonator according to the first exemplary embodiment of the present invention. In FIG. 1, the resonator according to the first embodiment has top-surface ground electrode 4 on the top surface of dielectric laminated substrate 3 and bottom-surface ground electrode 5 on the bottom surface of dielectric laminated substrate 3, each arranged so as to face the other. The inside of dielectric laminated substrate 3 interposed between top-surface ground electrode 4 and bottom-surface ground electrode 5 contains first and second high-impedance wiring 7a, 7b; first and second low-impedance wiring 8a, 8b; and first, second, and third columnar conductors 9a, 9b, 9c. First and second high-impedance wiring 7a, 7b are respectively arranged so as to face top- and bottom-surface ground electrodes 4, 5. Similarly, first and second low-impedance wiring 8a, 8b are respectively arranged so as to face top- and bottom-surface ground electrodes 4, 5.

First high-impedance wiring 7a is arranged near and parallel to top-surface ground electrode 4. Second high-impedance wiring 7b is arranged near and parallel to bottom-surface ground electrode 5. First high-impedance wiring 7a is arranged so as to face second high-impedance wiring 7b. Then, first columnar conductor 9a is connected to one end of first high-impedance wiring 7a and to one end of second high-impedance wiring 7b (both at the same side).

Here, the length of second columnar conductor 9b is made equal to that of third columnar conductor 9c. Second and third columnar conductor 9b, 9 are arranged on the same straight line. Here, the length of the first columnar conductor is larger than the sum of the lengths of the second and third columnar conductors.

The other end of first high-impedance wiring 7a is connected to one end of first low-impedance wiring 8a arranged so as to face first high-impedance wiring 7a through second columnar conductor 9b. The other end of first low-impedance wiring 8a is open with nothing connected thereto. In other words, first columnar conductor 9a is not electrically connected to first low-impedance wiring 8a.

Second low-impedance wiring 8b is arranged so as to face first low-impedance wiring 8a. Then, the other end of second low-impedance wiring 8b is connected to the other end of second high-impedance wiring 7b through third columnar conductor 9c. First low-impedance wiring 8a is not electrically connected to second low-impedance wiring 8b. The one end of second low-impedance wiring 8b is open with nothing connected thereto. In other words, first columnar conductor 9a is not electrically connected to second low-impedance wiring 8b.

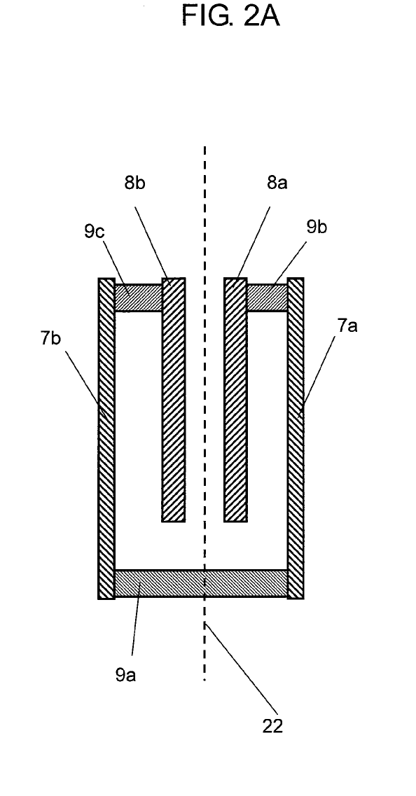

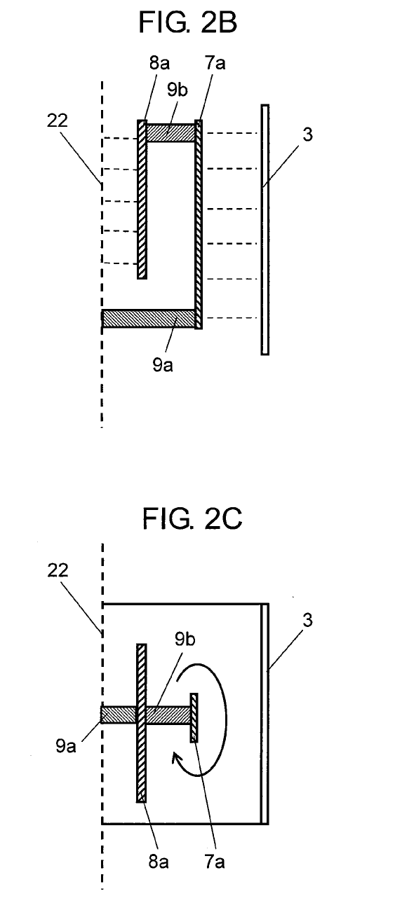

FIG. 2A is a sectional view of the resonator according to the first embodiment of the present invention. FIG. 2B is an enlarged figure of one half side of the sectional view of the resonator according to the first embodiment of the present invention. FIG. 2C is a sectional view of FIG. 2B viewed from the top surface. In FIGS. 2A through 2C, the resonator according to the first embodiment of the present invention is supposed to have virtual ground surface 22 (shown by the dashed-dotted line) with the center between first low-impedance wiring 8a and second low-impedance wiring 8b being a boundary. Accordingly, electric flux lines from first low-impedance wiring 8a and second low-impedance wiring 8b occur to virtual ground surface 22 (refer to FIG. 2B). Hence, the impedance of first low-impedance wiring 8a is determined by the distance between first low-impedance wiring 8a and virtual ground surface 22. In the same way, the impedance of second low-impedance wiring 8b is determined by the distance between second low-impedance wiring 8b and virtual ground surface 22.

Meanwhile, electric flux lines from first high-impedance wiring 7a occur to top-surface ground electrode 4 as shown by the broken lines in FIG. 2B. Consequently, the impedance of first high-impedance wiring 7a is determined by the distance between first high-impedance wiring 7a and top-surface ground electrode 4. In the same way, electric flux lines from second high-impedance wiring 7b occur to bottom-surface ground electrode 5. Consequently, the impedance of second high-impedance wiring 7b is determined by the distance between second high-impedance wiring 7b and bottom-surface ground electrode 5.

Currents flow in opposite directions between first high-impedance wiring 7a and first low-impedance wiring 8a; and second high-impedance wiring 7b and second low-impedance wiring 8b. However, the line width of first high-impedance wiring 7a is different from that of first low-impedance wiring 8a, for instance, and thus a current generated in first high-impedance wiring 7a is not completely canceled by that in first low-impedance wiring 8a. Consequently, magnetic force lines occur as shown by the solid line in FIG. 2C to influence each impedance.

For instance, the line width of the first high-impedance wiring may be made smaller than that of the first low-impedance wiring. The line width of the second high-impedance wiring may be made smaller than that of the second low-impedance wiring.

Thus, the impedances of first and second high-impedance wiring 7a, 7b are respectively determined by the distance to top-surface ground electrode 4 and to bottom-surface ground electrode 5, namely the conductor length of first columnar conductor 9a. Accordingly, the resonance frequency of the resonator according to the first embodiment of the present invention can be controlled.

Further, the distance between first low-impedance wiring 8a and virtual ground surface 22 is determined by the conductor length of second columnar conductor 9b. The distance between second low-impedance wiring 8b and virtual ground surface 22 is determined by the conductor length of third columnar conductor 9c. Accordingly, the resonance frequency of the resonator according to the first embodiment of the present invention can be controlled.

With the above-described configuration, a half-wavelength resonator can be structured three-dimensionally, and thus the area size of the resonator can be made smaller than the sum of the area sizes of first high-impedance wiring 7a, second high-impedance wiring 7b, first low-impedance wiring 8a, and second low-impedance wiring 8b. Consequently, the area size of a resonator can be reduced.

For instance, assumption is made that the relative dielectric constant of dielectric laminated substrate 3 shown in FIG. 1 is 57, the area size of dielectric laminated substrate 3 is 2,500 μm by 2,000 μm, and the thickness of dielectric laminated substrate 3 is 500 μm. The electrode thickness of top-surface ground electrode 4 and bottom-surface ground electrode 5 is 10 μm. The line width of first high-impedance wiring 7a and second high-impedance wiring 7b is 200 μm; the line length, 775 μm; and the line thickness, 10 μm. The line width of first low-impedance wiring 8a and second low-impedance wiring 8b is 600 μm; the line length, 1,025 μm; and the line thickness, 10 μm. Further, the center of the distance between first low-impedance wiring 8a and second low-impedance wiring 8b is made agree with the center of the thickness of the dielectric laminated substrate. The diameter of each of first columnar conductor 9a, second columnar conductor 9b, and third columnar conductor 9c is 100 μm.

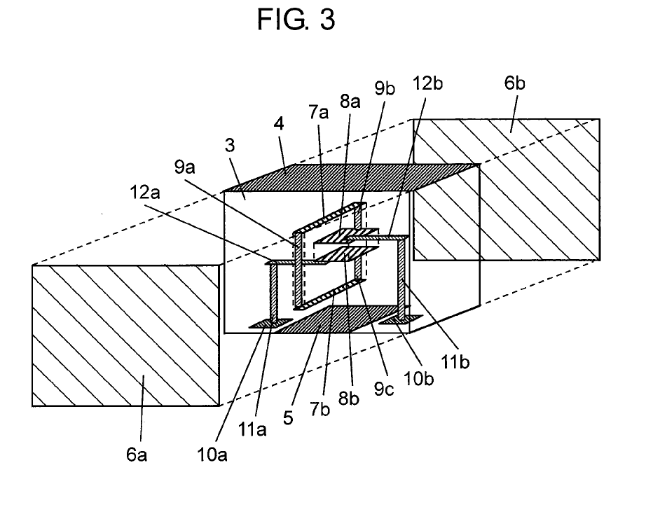

FIG. 3 is a perspective view showing an example configuration for characterizing the resonator according to the first embodiment of the present invention. In FIG. 3, I/O terminals 10a, 10b placed at bottom-surface ground electrode 5 are provided therefrom with I/O wiring 12a, 12b through columnar conductors 11a, 11b. I/O wiring 12a, 12b are respectively arranged so as to capacitively couple to the open ends of first low-impedance wiring 8a and second low-impedance wiring 8b at an interval of 20 μm in an area size of 200 μm by 100 μm.

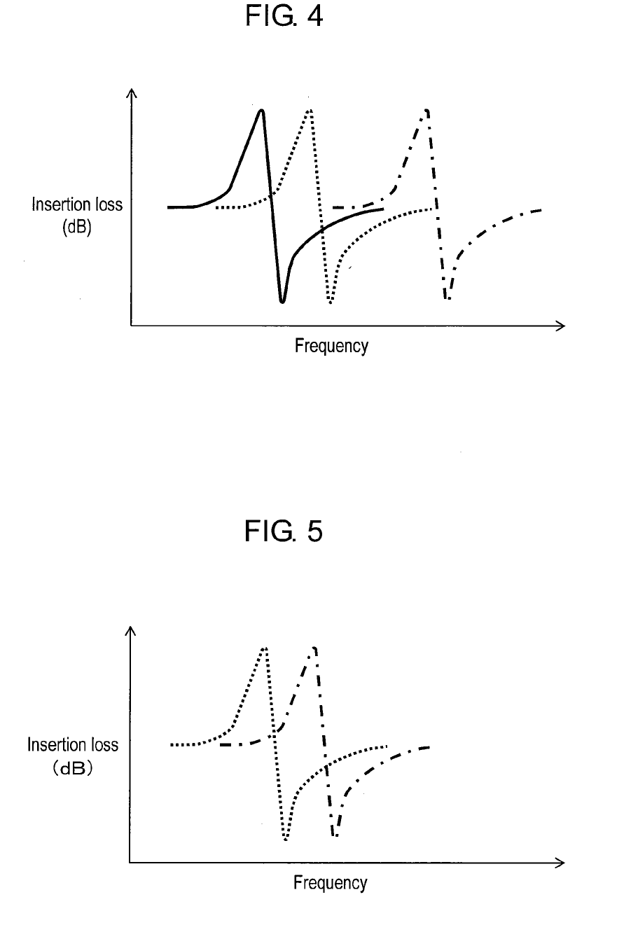

FIG. 4 is a characteristic diagram of the resonator according to the first embodiment of the present invention. In FIG. 4, the conductor length of first columnar conductor 9a is variable (140, 260, 380 μm). The length of 140 μm corresponds to the solid line; 260 μm, broken line; and 380 μm, dashed-dotted line. In this case, increasing the conductor length of first columnar conductor 9a raises the resonance frequency of the resonator.

FIG. 5 is another characteristic diagram of the resonator according to the first embodiment of the present invention. In FIG. 5, the conductor length of first columnar conductor 9a is fixed to 380 μm, while those of second columnar conductor 9b and third columnar conductor 9c are variable (110 μm and 140 μm respectively). The length of 110 μm corresponds to the broken line; and 140 μm, dashed-dotted line. In this case, extending second columnar conductor 9b and third columnar conductor 9c raises the resonance frequency of the resonator.

In this way, adjusting the conductor lengths of first columnar conductor 9a, second columnar conductor 9b, and third columnar conductor 9c allows controlling the resonance frequency.

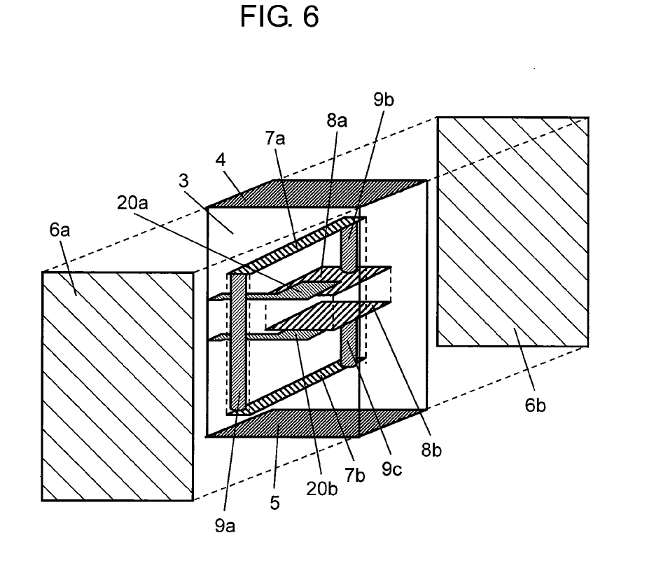

FIG. 6 is a perspective view of another resonator according to the first embodiment of the present invention. In FIG. 6, loading capacitance 20a is provided between first low-impedance wiring 8a and first high-impedance wiring 7a, at the open end of first low-impedance wiring 8a. Loading capacitance 20b is provided between second low-impedance wiring 8b and second high-impedance wiring 7b, at the open end of second low-impedance wiring 8b. With such a composition, the resonance frequency of the resonator can be further shifted toward a lower frequency.

In the first embodiment of the present invention, to avoid electromagnetic field coupling with another electronic appliance, both top-surface ground electrode 4 and bottom-surface ground electrode 5 are desirably connected to side-surface ground electrodes 6a, 6b electrically. Here, the same effect is provided even if top-surface ground electrode 4 is electrically connected to bottom-surface ground electrode 5 using a columnar conductor instead of side-surface ground electrodes 6a, 6b.

In the first embodiment of the present invention, first high-impedance wiring 7a is different from second high-impedance wiring 7b in shape; first low-impedance wiring 8a is different from second low-impedance wiring 8b in shape, which allows a coupling device for such as I/O coupling and interstage coupling to be provided more easily. Further, second columnar conductor 9b is different from third columnar conductor 9c in conductor length, which allows a coupling device for such as I/O coupling and interstage coupling to be provided more easily. That is, such an asymmetric structure allows correcting fluctuation in impedance of the resonator caused by a coupling device.

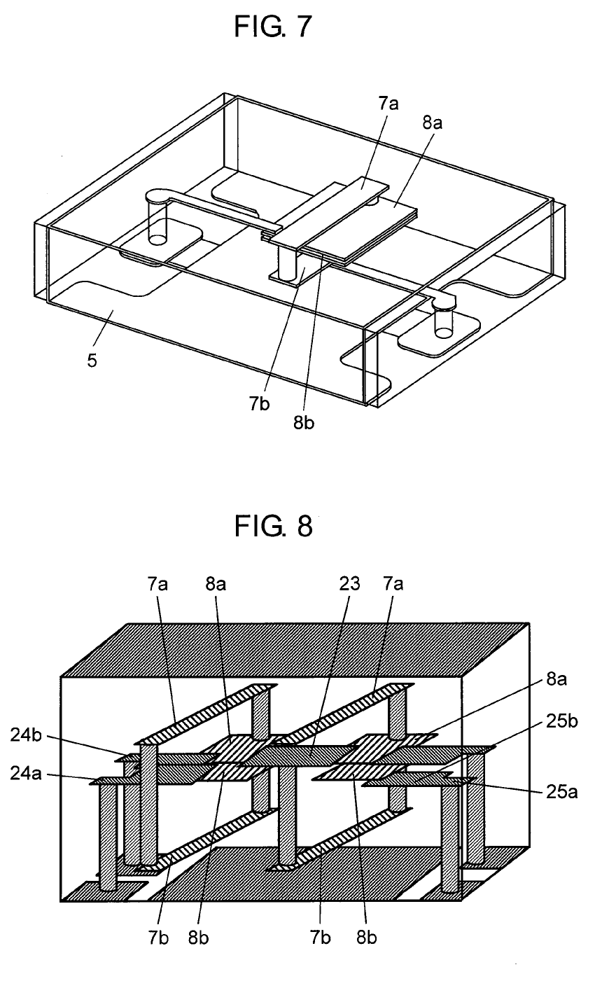

FIG. 7 is a perspective view showing another embodiment of the resonator according to the first embodiment of the present invention. In FIG. 7, enlarging the shape of bottom-surface ground electrode 5 provides a more stable ground surface.

FIG. 8 is a perspective view showing a filter including the resonator according to the first embodiment of the present invention. In FIG. 8, two or more resonators of the present invention are used; they are connected with each other through electromagnetic field coupling by interstage coupling device 23; and by input coupling devices 24a, 24b and output coupling devices 25a, 25b. With such a structure, a further smaller filter can be produced.

Incorporating such a filter further reduces the size of an electronic device contained in a mobile phone and other appliances.

### Second Exemplary Embodiment

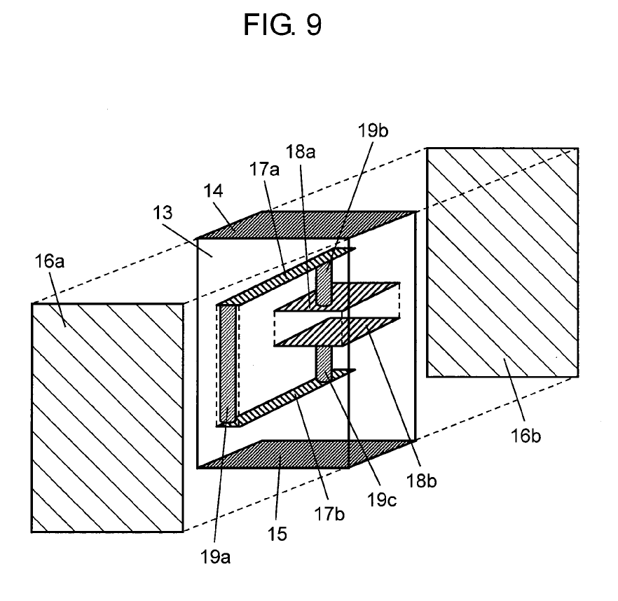

FIG. 9 is a perspective view of a resonator according to the second exemplary embodiment of the present invention. In FIG. 9, the top and bottom surfaces of dielectric laminated substrate 13 respectively have top-surface ground electrode 14 and bottom-surface ground electrode 15 arranged thereon so as to face each other. The inside of dielectric laminated substrate 13 interposed between top-surface ground electrode 14 and bottom-surface ground electrode 15 contains first high-impedance wiring 17a, second high-impedance wiring 17b, first low-impedance wiring 18a, second low-impedance wiring 18b, first columnar conductor 19a, second columnar conductor 19b, and third columnar conductor 19c. First high-impedance wiring 17a and second high-impedance wiring 17b are arranged so as to face top-surface ground electrode 14 and bottom-surface ground electrode 15, respectively. Similarly, first low-impedance wiring 18a and second low-impedance wiring 18b are arranged so as to face top-surface ground electrode 14 and bottom-surface ground electrode 15, respectively.

First high-impedance wiring 17a is arranged near and parallel to top-surface ground electrode 14. Second high-impedance wiring 17b is arranged near and parallel to bottom-surface ground electrode 15. First high-impedance wiring 17a and second high-impedance wiring 17b are arranged facing each other. Further, first columnar conductor 19a is connected to one end of first high-impedance wiring 17a and to one end of second high-impedance wiring 17b (both at the same side).

The second embodiment of the present invention is different from the first in the following points. That is, the other end of first high-impedance wiring 17a is connected to one end of first low-impedance wiring 18a arranged parallel to and not facing first high-impedance wiring 17a through second columnar conductor 19b. Similarly, the other end of second high-impedance wiring 17b is connected to one end of second low-impedance wiring 18b arranged parallel to and not facing second high-impedance wiring 17b through third columnar conductor 19c. With such a configuration, electromagnetic field coupling can be avoided between first high-impedance wiring 17a and first low-impedance wiring 18a. Similarly, electromagnetic field coupling can be avoided between second high-impedance wiring 17b and second low-impedance wiring 18b. Accordingly, a resonator can be designed easily.

Here, second low-impedance wiring 18b is arranged so as to face first low-impedance wiring 18a. The other end of first low-impedance wiring 18a is open with nothing connected thereto. Similarly, the other end of second low-impedance wiring 18b is open with nothing connected thereto.

The operation principle of the resonator according to the second embodiment of the present invention is the same as that of the first embodiment. Specifically, the resonance frequency of a resonator can be adjusted by adjusting the conductor lengths of first columnar conductor 19a, second columnar conductor 19b, and third columnar conductor 19c.

With such a configuration, a half-wavelength resonator can be structured three-dimensionally, thereby reducing the area size of the resonator.

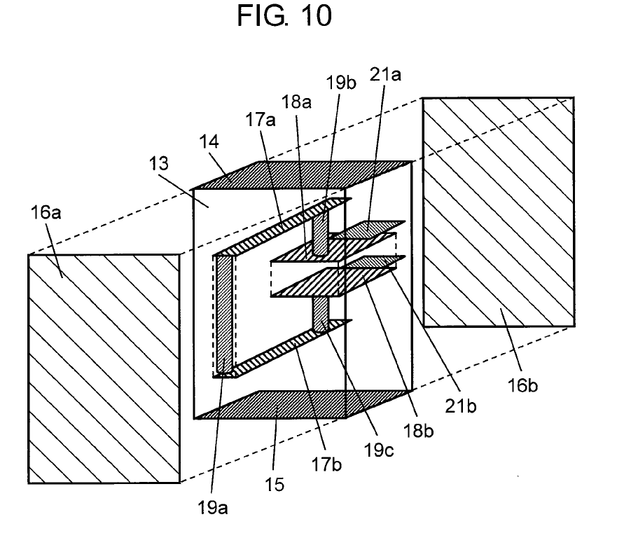

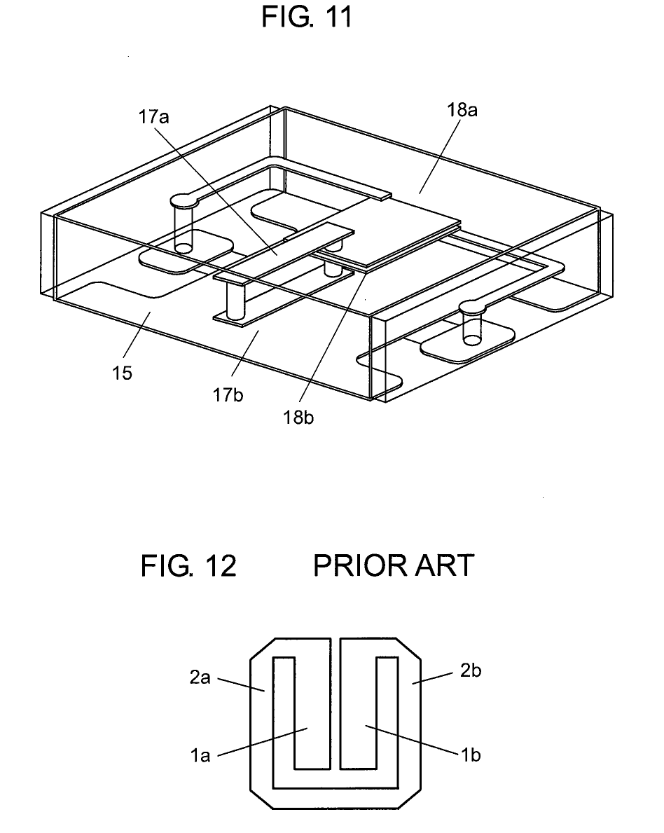

FIG. 10 is a perspective view of another resonator according to the second embodiment of the present invention. In FIG. 10, loading capacitance 21a is provided between first low-impedance wiring 18a and first high-impedance wiring 17a, at the open end of first low-impedance wiring 18a. Similarly, loading capacitance 21b is provided between second low-impedance wiring 18b and second high-impedance wiring 17b, at the open end of second low-impedance wiring 18b. With such a configuration, the resonance frequency of the resonator can be further shifted toward a lower frequency.

In the second embodiment of the present invention, to avoid electromagnetic field coupling with another electronic appliance, side-surface ground electrodes 16a, 16b, top-surface ground electrode 14, and bottom-surface ground electrode 15 are desirably connected to each other electrically. The same effect is provided even if top-surface ground electrode 4 is electrically connected to bottom-surface ground electrode 15 using a columnar conductor instead of side-surface ground electrodes 16a, 16b.

In the second embodiment of the present invention, first high-impedance wiring 17a is different from second high-impedance wiring 17b in shape; first low-impedance wiring 18a is different from second low-impedance wiring 18b in shape, which allows a coupling device for such as I/O coupling and interstage coupling to be provided more easily. Further, second columnar conductor 19b is different from third columnar conductor 19c in conductor length, which allows a coupling device for such as I/O coupling and interstage coupling to be provided more easily. That is, such an asymmetric structure allows correcting fluctuation in impedance of the resonator caused by a coupling device.

FIG. 11 is a perspective view showing another resonator according to the second embodiment of the present invention. In FIG. 11, enlarging the shape of bottom-surface ground electrode 15 provides a more stable ground surface.

Further, using two or more resonators of the present invention and connecting them through electromagnetic field coupling provides an ever-smaller filter. Incorporating the filter further reduces the size of an electronic device contained in a mobile phone and other appliances.

### INDUSTRIAL APPLICABILITY

A resonator of the present invention provides an effect that reduces the area size and is useful for various types of electronic appliances such as a mobile phone.

1. A resonator comprising:
a top-surface ground electrode;
first high-impedance wiring plate-like, arranged parallel to the top-surface ground electrode;
second high-impedance wiring plate-like, arranged so as to face the first high-impedance wiring;
a first columnar conductor electrically connecting the first high-impedance wiring to the second high-impedance wiring;
first low-impedance wiring arranged between the first high-impedance wiring and the second high-impedance wiring;
a second columnar conductor electrically connecting the first high-impedance wiring to the first low-impedance wiring;
second low-impedance wiring arranged between the first low-impedance wiring and the second high-impedance wiring; and
a third columnar conductor electrically connecting the second high-impedance wiring to the second low-impedance wiring.

2. The resonator of claim 1,
wherein the first columnar conductor is connected to one end of the first high-impedance wiring, and
wherein the second columnar conductor is connected to an other end of the first high-impedance wiring.

3. The resonator of claim 2,
wherein the first columnar conductor is connected to one end of the second high-impedance wiring, and
wherein the third columnar conductor is connected to an other end of the second high-impedance wiring.

4. The resonator of claim 1,
wherein a line width of the first high-impedance wiring is made smaller than that of the first low-impedance wiring.

5. The resonator of claim 4,
wherein a line width of the second high-impedance wiring is made smaller than that of the second low-impedance wiring.

6. The resonator of claim 1,
wherein a length of the second columnar conductor is equalized to that of the third columnar conductor.

7. The resonator of claim 1,
wherein the second columnar conductor and the third columnar conductor are arranged on a same straight line.

8. The resonator of claim 1,
wherein a length of the first columnar conductor is made larger than a sum of lengths of the second columnar conductor and the third columnar conductor.

9. A filter comprising the resonator of claim 1.
